(19) United States
(12) Patent Application Publication
(10) Pub. No.: US 2006/0196725 A1
(43) Pub. Date: Sep. 7, 2006

(54) Pickup truck game stand device

(76) Inventor: Bruce R. Lee, Rappahannock, VA (US)

Correspondence Address: KLIMA LAW OFFICES, P.L.L.C., P. O. Box 2855, Stafford, VA, 22555-2855, US

(21) Appl. No.: 11/072,716

(22) Filed: Mar. 7, 2005

(51) Int. Cl. E06C 5/00

(52) U.S. Cl. 182/127

(57) ABSTRACT

A pickup truck game stand device and a game stand device for use with a pickup truck. The game stand device including telescoping and/or folding ladder sections connected together by a platform portion when assembled.

### FIELD OF THE INVENTION

The present invention is directed to a pickup truck and game stand device, and a game stand device for use with a pickup truck.

### BACKGROUND OF THE INVENTION

Currently, tree stands or game stands for trees are popular for hunting. Specifically, a tree stand can be purchased by a hunter at a variety of stores including sporting goods, and taken to a site for hunting. The tree stands come in separate components or pieces in a cardboard box, and then erected on a tree by the hunter. Most tree stands include a two-piece or three-piece ladder, one or more braces for anchoring the ladder portions to the trunk of a tree, and a platform connecting to the ladder. Optionally, the tree stand can include a seat for one or more persons, a railing, and a tent or roof for sheltering the hunter from the elements.

The current tree stands are configured and designed to directly attach to a tree and be supported thereby. For example, the ladder portions are constructed of square tubular steel and the platform is constructed of steel tubing or channel combined with a steel mesh plate for flooring welded to the steel tubing or channel. The braces are made of square steel tubing having one end configured to connect to a tree the other end designed to connect to the ladder and/or platform. The platform is typically provided with a portion specifically designed to anchor the platform to the tree, for example, with wire cables and/or nylon straps.

The current tree stands require some time to assemble and test to ensure the tree stand is properly constructed and anchored to the tree for use. Once anchored to a tree, the tree stand is left on the tree typically during the duration of the hunting season.

Hunting using a pickup truck is currently gaining popularity. The hunter's track and follow their prey using a pickup truck. In some instances, the hunters stand up in the truck bed of the pickup truck and wait and then shoot at prey from the vantage of the height of the pickup truck. However, some game, in particular deer, can still see movement and/or hear noises from the hunters sitting or standing in the truck bed of a pickup truck, and thus, the pickup truck is not typically an effective game stand by itself. Thus, there exists a need for both a pickup truck combined with a game stand device and a game stand device itself configured for use with a pickup truck so that the pickup truck becomes a convenient and effective game stand.

### SUMMARY OF THE INVENTION

A first object of the present invention is to provide a pickup truck and a game stand device.

A second object of the present invention is to provide a game stand device for use with a pickup truck.

A third object of the present invention is to provide a portable game stand device for use with a pickup truck.

A fourth object of the present invention is to provide a collapsible game stand device for use with a pickup truck.

A fifth object of the present invention is to provide a pickup truck game stand device including a storage box containing a foldable or collapsible game stand.

A sixth object of the present invention is to provide a pickup truck in combination with a game stand device configured to cooperate with the truck bed of the pickup truck.

A seventh object of the present invention is to provide a game stand device for use with a truck bed of a pickup truck.

A eighth object of the present invention is to provide the combination of a pickup truck and a game stand device configured to be supported by the bed of the pickup truck.

A ninth object of the present invention is to provide a game stand device supported by the truck bed of a pickup truck.

A tenth object of the present invention is to provide the combination of a pickup truck and a game stand device supported by the side rails of the truck bed portion of the pickup truck.

A eleventh object of the present invention is to provide a game stand device configured to be supported by the side rails of a truck bed portion of a pickup truck.

The present invention is directed to the combination of pickup trick and game stand device, and a game stand device itself for use with a pickup truck, in particular a portable and/or collapsible game stand device.

A preferred embodiment of the present invention includes a pickup truck having a truck bed portion and side rails in combination with a game stand device cooperating with the truck bed and/or truck bedside rails. Specifically, the game stand is supported by the truck bed and/or truck bed portion side rails. Preferably, the game stand device is also connected or anchored to the pickup truck, preferably by the truck floor of the bed portion and/or truck bed portion side rails to form a structural unit with the pickup truck itself. In this manner, the game stand device will not fall or tip over during use, especially when one or more persons are located high on the platform of the game stand device. Optionally, the pickup truck can be provided with more or stabilizers, for example, including one or more mechanical, electrical and/or hydraulic jacks with or without out riggers making direct ground contact to prevent swaying or tipping of the pickup truck during use. However, most pickup trucks have sufficient stability and weight so that a game stand device according to the present invention can be constructed or designed to be safely used with the game stand without added stabilizers or jacks for the pickup truck.

The game stand device according to the present invention is preferably portable, collapsible and/or foldable to provide convenience of use. Specifically, the game stand device can be made in separate components and assembled together on the ground or in the truck bed of the pickup truck to erect the game stand device. More preferably, the game stand device includes a box, preferably a portable storage box, containing a collapsible game stand device. Preferably, the storage box is provided with a lid portion to cover and protect the collapsed game stand device during storage and non-use. Optionally, the storage box unit can be provided with a lock to prevent access to the game stand device. The collapsible game stand device fits entirely within the storage box during storage, and can be easily lifted out of the box unit and erected. In some embodiments, the game stand device is designed to be totally removed from the box unit, however, more preferably, the game stand is structurally connected to the box and remains so after being erected. For example, a lower portion of the game stand device is pivotably connected to the box and an upper portion of the game stand lifts out of the box to an erect position.

The storage box unit can be configured to be supported by the floor of the bed portion of the pickup truck and/or can be supported by the side rails of the truck bed portion. In a preferred embodiment, the storage box unit is supported by the top of the side rails and suspended there between. The storage box unit is also preferably directly connected to the pickup truck, for example, by using mechanical fasteners (e.g. bolts, nuts, rivets, mechanical anchors, tie bolts, welding or using some other suitable fastening technique) so that the box unit is well anchored to the pickup truck, preferably to the truck bed portion of the pickup truck.

In a preferred embodiment, the game stand device includes a storage box unit containing a pair of foldable ladder sections. The foldable ladder sections can be sized to be slightly less than the length of the storage box unit, and can be a single ladder section, two foldable ladder sections, or three or more ladder sections designed to pivot and unfold when raised out of the box unit. In a preferred embodiment, the bottom ends of the ladder portions are anchored by pivots or hinges located in a bottom portion or sides of the storage box unit near or adjacent to the ends of the storage box unit. When the ladder portions are raised, a platform portion and cross members are connected between the ladder sections to provide a A-frame or modified A-frame structure. In some embodiments, the platform portion is a separate component, preferably stored within the storage box unit and can be connected at both ends to the ladder sections. In a more preferred embodiment, one end of the platform portion is hintedly connected to one of the ladder sections while the other end can be releaseably connected (e.g. by a hinge) to the other ladder section to erect the game stand device. In this embodiment, the platform portion pivots or swings away from the one ladder section that it is connected to as that particular ladder section is raised out of the box unit.

The game stand device according to the present invention can optionally include a seat for one or more persons, a platform railing, a tent covering the platform, and/or a roof. Further, additional stabilizer bars, cables, wires, straps, ropes or other suitable anchoring devices can be used to further secure the game stand device to the pickup truck. For example, four (4) ties or ropes or straps can be extended from the platform portion of the game stand device when erected to four (4) corner anchors of the truck bed portion and/or other portions of the pickup truck. In this manner the game stand device when erected can be substantially stabilized and act or perform as a single structure unit with the pickup truck itself. However, it is preferred that the game stand device is designed and/or constructed so that these additional stabilizers are not required to provide safe use and added convenience in quickly storing and erecting the game stand device.

### BRIEF DESCRIPTION OF THE DRAWINGS

FIG. 1 is a perspective view of a preferred embodiment of a pickup truck and game stand device according to the present invention.

FIG. 2 is a side elevational view of a pickup truck and game stand device shown in FIG. 1.

FIG. 3 is a front elevational view of a pickup truck and game stand device shown in FIG. 1.

FIG. 4 is a rear elevational view a pickup truck and game stand device shown in FIG. 1.

FIG. 5 is a perspective view of the game stand device by itself removed from the pickup truck shown in FIG. 1-4.

FIG. 6 is a side elevational view of another embodiment of the pickup truck and game stand device according to the present invention.

FIG. 7 is a further embodiment of the pickup truck and game stand device according to the present invention.

FIG. 8 is a side elevational view of another further embodiment of the pickup truck and game stand device according to the present invention.

FIG. 9 is a side elevational view of an embodiment of the pickup truck and game stand device illustrating a connection between the game stand device and the upper rail of the bed portion of the pickup truck.

FIG. 10 is a side elevational view of a pickup truck and game stand device illustrating the connection of the game stand device with the upper side rail of the truck bed portion of the pickup truck.

FIG. 11 is a side elevational view of the game stand device installed in the truck bed portion of the pickup truck as shown in FIG. 7.

FIG. 12 is a broken away side elevational view of the game stand device shown in FIG. 11 showing the contents thereof.

FIG. 13 is a side elevation view of the game stand device shown in FIG. 11 and 12 partially erected.

FIG. 14 is a partial broken away side evelational view of a showing a quick disconnect arrangement for securing a cross member to a leg a portion.

FIG. 15 is a partial broken away side elevational view showing a cross member connected to the quick disconnect fastener by a split ring.

FIG. 16 is a side elevational view of an even further embodiment of the pickup truck game stand device according to the present invention.

FIG. 17 is a partial broken away side elevational detail view of a portion of one (1) ladder section showing the connection with an upper side rail of the truck bed portion of the pickup truck.

FIG. 18 is a back elevational view of the pickup truck game stand device shown in FIG. 16 with the game stand device in a collapsed mode.

FIG. 19 is a back elevational view of the game stand device shown in FIG. 18 partially assembled.

FIG. 20 is a back elevational view of the game stand device shown in FIGS. 18 and 19 fully assembled.

### DETAILED DESCRIPTION OF PREFERRED EMBODIMENTS

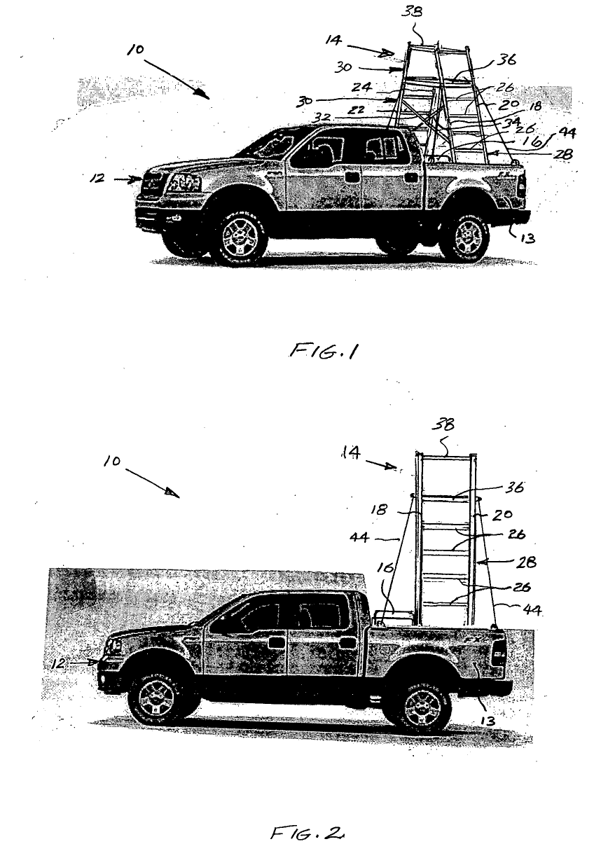

An embodiment of the pickup truck game stand device 10 according to the present invention shown in FIGS. 1-4.

The pickup truck game stand device 10 includes the combination of a pickup truck 12 and a game stand device 14. The game stand device 14 is preferably configured to cooperate with the bed portion of the pickup truck 12. In the embodiments shown in FIGS. 1-4, the game stand device 14 is located just behind a tool box 16 in the truck bed portion 13 of the pickup truck 12.

The game stand device 14 includes four (4) leg portions 18, 20, 22, 24. A set of wrungs 26 are provided between the leg portions 18, 20 and another set of wrungs 26 are provided between the leg portions 22, 24 defining two (2) separate ladder sections 28, 30. The game stand device 14 is configured so that the ladder sections 28, 30 are tilted towards each other and fixed in this configuration by cross members 32, 34.

A platform portion 36 is supported by and suspended between ladder sections 28, 30. A railing 38 is provided at the upper end of the ladder section 28, 30 located above the platform portion 36.

The game stand device 14 is preferably configured or designed to be collapsible, however, some embodiments may include a fixed structure when constructed or erected. For example, the cross members 32, 34 can be removably connected to the ladder sections 28, 30 by quick disconnect fasteners (e.g. pins extending from ladder sections 28, 30 having holes configured to receive locking rings. See FIGS. 14 and 15, and description below). Further, the ladder sections 28, 30 can be configured or designed so as to fold into two or more portions preferably with hinged locking devices to positively lock and unlock the ladder portions of each ladder sections 28, 30. In addition, the platform portion 36 can be removably and quickly connected and unconnected to an additional wrung 26 of the ladder section 28, 30 and or the leg portions 18, 20, 22, 24. Finally the railing 38 can be configured to be removably connected to the ladder sections 28, 30 by quick disconnect fasteners.

The game stand device 14 is preferably constructed of lightweight high strength metal, fiberglass or composite tubing (e.g. round cross section, rectangular cross section square cross section) with the wrungs 26 welded or fastened to the leg portions 18, 20, 22, 24. The platform portion 36 can be made from tubing having one or more cross members supporting a decking material (e.g. steel plate, steel mash, aluminum plate, aluminum metal, diamond plate, fiberglass, plastic, wood). The decking is preferably coated with a non-slip surface. Further, preferably all portions of the game stand device 14 are preferably coated or treated to provide rust and sun protection to the surface and to camouflage the game stand device 14.

The game stand device 14 is preferably configured to be supported by the bed portion of the pickup truck 12. However, the game stand device can be supported or partially supported by other portions or components of the pickup truck (e.g. bumper, hood, roof, cab, frame, hitch). For example, the game stand 14, as shown in FIG. 5 is provided with stabilizing members 40, 42 (e.g. outriggers) configured to widen the stance of the ladder sections 28, 30 to prevent tipping of the game stand device 14. The stabilizing members 40, 42 are positioned in the lower corners of the truck bed portion 13 of the pickup truck in and along the corner where the side rails of the pickup truck raise from the floor of the truck bed portion 13 of the pickup truck. The stabilizing members 40, 42 can be free standing or connected or fastened to the truck bed portion 13 of the pickup truck 12. In addition securing ropes, lines, cables or straps 44 can be connected between the truck bed portion 13 of the pickup truck 12 and anchoring positions on the game stand device 14. Preferably these anchoring positions are higher positions (e.g. at or around the height of the platform portion 36) to stabilize the game stand device 14 from tipping relative to the truck bed portion 13 of the pickup truck during use. For example, the leg portions 18, 20, 22, 24 can be provided with loop connectors 45 to provide anchoring points for straps 44 on the game stand device 14.

Another embodiment of the game stand device 114 is shown in FIG. 6.

In this embodiment, the flexible securing straps 44 of the embodiment shown in FIGS. 1-4 is replaced with rigid outrigging support members 146 (e.g. made of steel tubing) connecting between the leg portions 118, 120, 122, 124 and/or platform portion 136 and the upper ends of the side rails of the truck bed portion 13 of the pickup truck 12. Specifically, the pickup truck 12 is provided with three (3) receivers in the top of the rails of the truck bed portion 13 of the pickup truck, and the bottom ends of the outrigging support members 146 fit into four (4) of these receivers. In addition removable bolts or pins can further secure the bottom ends of the outrigging members 146 within the receivers in the top of the rails of the truck bed portion 13 of the pickup truck 12. The outrigging members 146 can be removably connected to, near or adjacent to the platform portion 136 of the game stand device 146 to erect or take down the game stand device 14. The outrigging members 146 significantly further stabilize the game stand device 14, relative to the pickup truck 12 and prevent it from tipping over during use.

A further embodiment of the game stand device 214 according to the present invention is shown in FIG. 7.

The game stand device 214 includes a game stand device the same or similar to the game stand device 14 shown in FIGS. 1-4 combined with a storage box 248. The storage box 248 is provided with a hinged lid portion 250. The game stand device 214 is configured to fold out of the storage box 248 to erect the game stand device 214, and then collapse or break down into the storage box 248 allowing the lid 250 to be closed to store and protect the game stand device 214 during non-use. The lid portion is preferably provided with a lock 251 (See FIG. 11). The details of this embodiment will be further described in detail below.

Another further embodiment of the game stand device 314 according to the present invention is shown in FIG. 8.

The game stand device 314 is similar to the game stand device 114 shown in FIG. 6, however, it is provided with an additional cantilever platform 352 extending forward and over the cab of the pickup truck 12. The additional platform 352 provides an additional shooting or observing platform for a hunter to stand unobstructed and at a height different from that of the platform 336.

The game stand device according to the present invention preferably cooperates with the truck bed portion 13 of the pickup truck 12. The game stand device can be configured to be supported by the floor of the truck bed portion 13 and/or the top of the side rails of the truck bed portion 13 of the pickup truck 12.

The embodiment of the game stand device 14 shown in FIGS. 1-4 is supported by the floor of the truck bed portion 13 of the pickup truck 12. In the embodiment of FIG. 9, the ladder section 428 is provided with an outrigging member 446 having three (3) connector portions 454 configured to be received within the three (3) receivers provided in the top of the side rails of the truck bed portion 13 of the pickup truck 12. In the embodiment shown in FIG. 10, the leg portions 518 and 520 are bent outwards and them downwards to provide connector portions 554 to be received within two (2) of the three (3) receivers provided in the top of the side rails of the truck bed portion 13 of the pickup truck 12. The connector portions 454 and 554 can be further connected to the receivers by removable bolts and/or pins.

A detailed description of the game stand device 214 shown in FIG. 7 is further described and shown in FIGS. 11-15.

The game stand device 214 is configured to be supported by the top of the side rails of the bed portion of the pickup truck 12 as shown in FIG. 11. Specifically, the game stand device 214 includes a storage box 248 having end portions 248a resting on top of the side rails 12a of the truck bed portion 13 of the pickup truck 12. A center portion of the storage box 248b is suspended above the floor 12b of the truck bed portion 13 of the pickup truck 12. The storage box 248 includes a lid portion 250 connected by hinges 253 thereto, as shown in FIG. 12. Inside the storage box 248 is stored all of the components of the game stand device 214 including the ladder sections 228, 230, platform portion 236, railing 238 and cross members 232 and 234. Specifically the ladder sections 228, 230 can be hingedly connected inside the storage box 248 by pivot connections 260, 262, respectively. The ladder section 228 is folded in three (3) sections 228a, 228b, 228c and the ladder section 230 is folded in three (3) sections 230a, 230b, 230c, as shown in FIG. 12.

The ladder sections 228, 230 are provided with locking hinges 228d, 228e and 230d, 230e, respectively. The locking hinges 228d, 228e, 230d, 230e are each provided with a handle for locking and unlocking these locking hinges to fold and unfold the ladder sections 228, 230 during assembly or disassembly of the game stand device 214.

As shown in FIGS. 14 and 15, the cross member 234 is removably connected to the leg 224 by pin connector 270 having a through hole 272 for accommodating a removable split ring 274. Specifically, the ends of the cross members 232, 234 are provided with through holes for accommodating the pin portion of the pin connector 270. The pin connector 270 is anchored to the leg 234 by end plate 276 and securing plate 278 and extends through a hole in the leg portion 224. For example, the pin connector 270 can have a fixed end plate 276 and when inserted through a hole in the leg portion 224 is then secured in place by the securing plate 278 that is pressed fitted or welded thereto.

The pickup truck and game stand device according to the present invention can be a single combined or assembled unit. Further, the present invention is also directed to a game stand device that can be added as a separate or stand-alone unit to a conventional pickup truck.

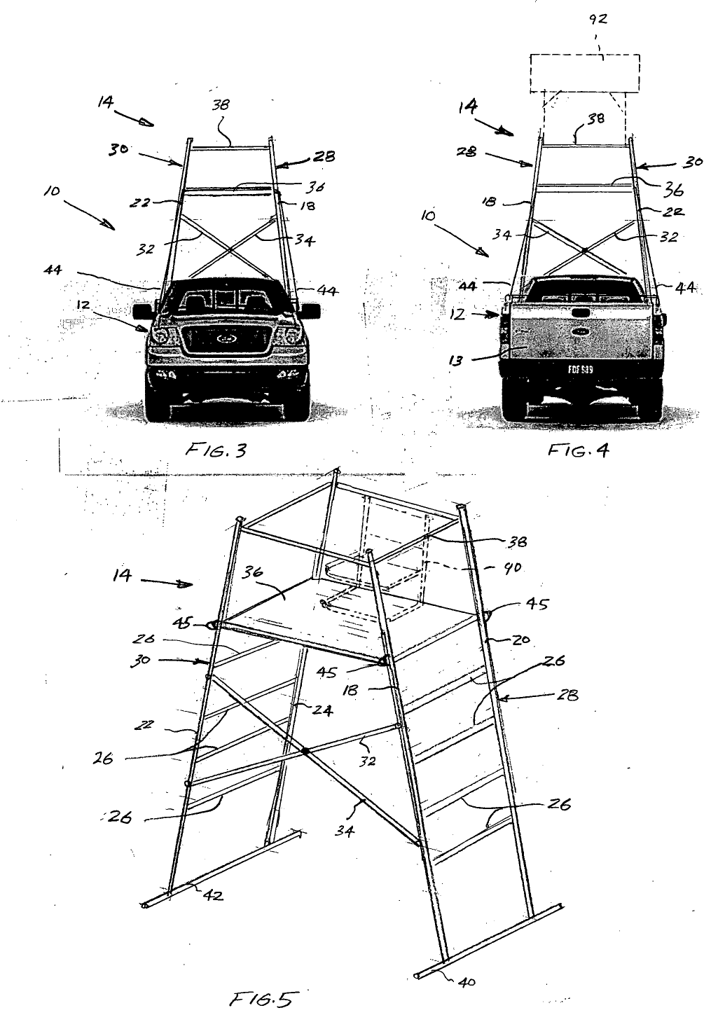

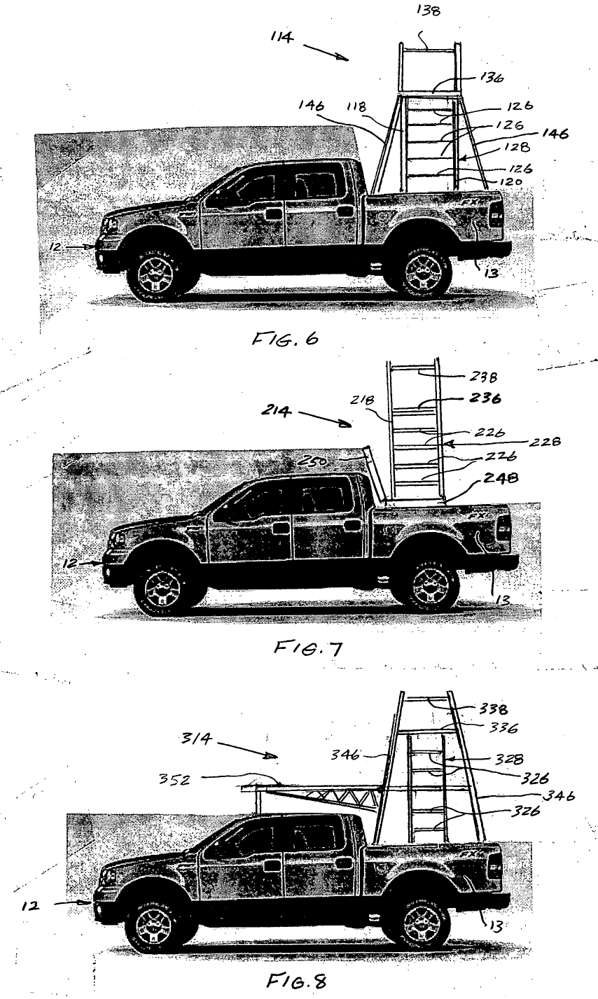

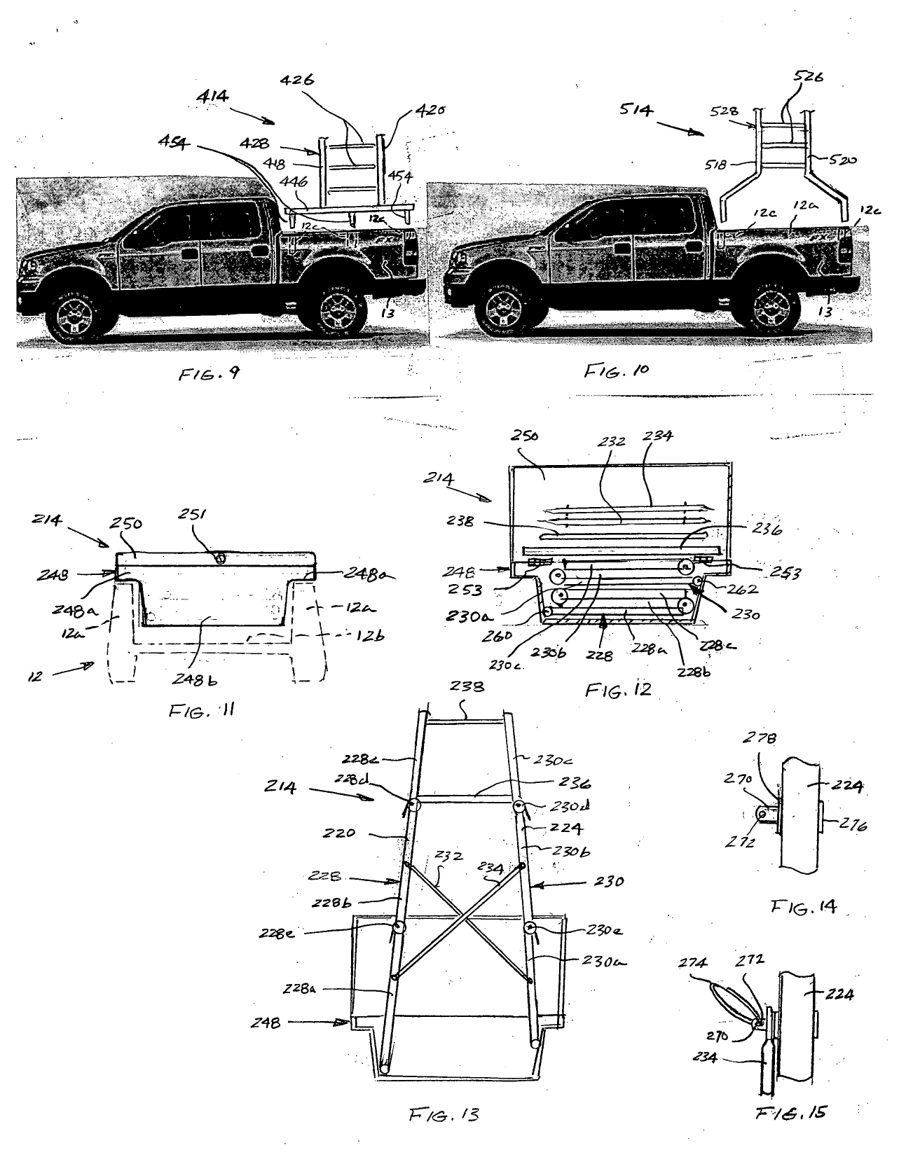

In the embodiment shown in FIGS. 1-4, for example, the game stand device 14 is erected on the ground on in the truck bed portion 13 of the pickup truck, and then secured from tipping by placement of the four (4) straps 44 extending from loop anchors located in the receivers provide in the upper ends of the side rails of the truck bed portion 13 of the pickup truck to the four (4) loop connectors 45. In this manner, the game stand device 14 is ready for use by a hunter. The hunter is able to climb up the game stand device 14 by either ladder section 28 or 30 to gain access to the platform portion 36. An optional seat 90 (See FIG. 5) and/or optional tent 92 (See FIG. 4) can be added to the game stand device 14 to make the game stand device 15 more comfortable for hunting. The rail 38 adds further safety to prevent the hunter from falling out of the platform portion 36 of the game stand device 14, and can further serve as a gun support while shooting.

The game stand device 14, for example, can be assembled at the beginning of hunting season and then collapsed or disassembled at the end of the hunting season and stored away for next year. It is preferred that the game stand device 14 be a collapsible type so that the game stand device 14 can be assembled and disassembled quickly the same day so that the game stand device 14 is disassembled and located in the bed portion of the pickup truck when not in use and during normal everyday transportation use of the pickup truck 12. When hunting, the pickup truck 12 can be driven to the desired hunting site, and then the game stand device 14 can be quickly erected or assembled. At the end of the day, the game stand device 14 again is then quickly disassembled to allow the pickup truck to be moved.

In the embodiment shown in FIGS. 7 and 11-15, after arriving at the hunting site, the hunter opens the lid portion 250 and removes the cross members 232 and 234 removably connected to the lid portion 250, and also removes the railing 238 and platform portion 236. Then the ladder section 230 is pulled upwardly and pivots about the pivot connection 262, and then is unfolded upwardly. Then the other ladder section 228 is lifted and pivoted about the pivot connection 260 and unfolded upwardly to make the A-frame type arrangement shown in FIG. 13. The handles of the locking hinges 228d, 228e, 230d, 230e are positioned to positively lock the ladder sections 228, 230 in a straight fully erected position. Then the cross members 232, 234 are connected to the legs by the pin connectors shown in FIG. 14, 15, after which the platform portion 236 and railing 238 are installed. The game stand device 214 is now readied for use.

An even further embodiment of the pickup truck and game stand device 414 according to the present invention is shown in FIGS. 16-20.

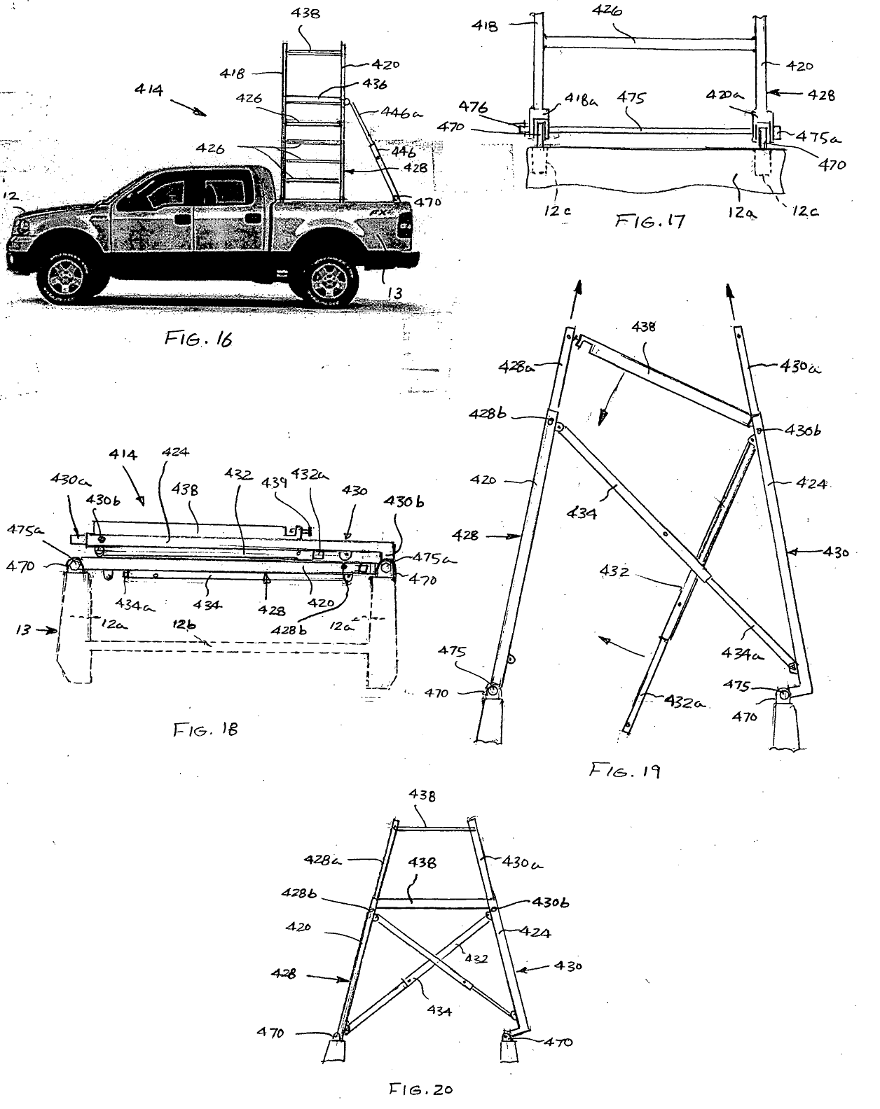

The game stand device 414 includes ladder sections 428, 430 connected to the side rails 12a, 12a of the truck bed portion 13 of the pickup truck 12. Specifically, as shown in FIG. 17, the side rail 12a is provided with a pair of eyelet connectors 470 secured directly to the side rails (e.g. drilled and mounted) and/or removably within two (2) receivers 472 of the side rail 12a. The leg portions 418, 420 are provided with yoke connectors 418a, 420a, respectively, having through holes. A long bolt 475 having a head portion 475a is passed through the holes in the yoke connectors 418a, 420a and the through holes of the eyelet connectors 470, and then secured in place a pin type fastener 476. The bolt 475 can be quickly inserted to connect both the ladder section 428 on one side of the pickup truck and ladder section 430 to the opposite side of the pickup truck for quick assembly. During disassembly, the bolts 475 are removed to disconnect the ladder sections 428, 430 from the side rails 12a, 12a.

As shown in FIG. 18, the game stand device 414 is shown in a collapsed mode. In this arrangement, the ladder section 430 overlays the ladder section 428 due to the L-shaped cantilever extension 430b. Alternatively, the ladder section 430 can be made wider or less wide than the ladder section 428 so that one ladder section nests within the other ladder section when collapsed. During assembly, as shown in FIG. 19, the ladder sections 428, 430 are pivoted upwardly, and then the cross members 432, 434 are pivoted outwardly to connect with the opposite ladder section. Preferably, the cross members 432, 434 are collapsible and extendable (e.g. one portion sliding within the other portion and being releaseably pinned together). Further, the platform 438 is preferably hinged connected to the ladder section 430, which platform portion 438 can be swung from one side of the ladder section 430 over the top and down onto the upper wrung 426 of the other ladder section 428. The platform portion 438 is provided with a quick disconnect-type fastener 439 (e.g. spring loaded pin) to lock the platform portion 438 to the upper wrung 426 of the ladder section 428 (e.g. provided with a through hole in the upper wrung 426 to accept the pin).

The upper telescoping ends 428a of the ladder sections 428, 430 are then extended upwardly until fully extended, and preferably locked in position by releasable pins 428b, 430b. For example, the leg portions 418, 420, 422, 424 have upper telescoping ends. Then the railing 438 is connected to the ladder sections 428a, 430a.

The game stand device 414 is stabilized by telescoping outriggers 446 having extension portions 446a connecting between the leg portions 420, 424 and a pair of eyelet connectors 470 provided in the very back receivers of the side rails 12a of the truck bed portion 13 of the pickup truck 12.

I claim:

1. A pickup truck game stand device, comprising:
a pickup truck having a truck bed portion with side rails;
a collapsible game stand connected to said side rails of said pickup truck, said game stand, including:
a pair of eyelet connectors provided on a top portion of both side rails of said pickup truck;
a pair of ladder sections pivotably connected to said side rails of said pickup truck by said eyelet connectors, said ladder sections including telescoping leg portions;
a platform portion pivotably connected at one end to one of said ladder sections, said platform portion configured to releasably connect to the other ladder section during assembly;
a pair of telescoping cross members each pivotably connected at upper ends to respective ladder sections, and releaseably connected at lower ends to the opposite respective ladder section;
a pair of telescoping outrigging members releasably connecting said ladder sections to respective side rails of said pickup truck; and
a railing removably connected to said ladder sections.

2. A pickup truck game stand device, comprising:
a pickup truck having a truck bed portion; and
a collapsible game stand releaseably connected to said pickup truck, said game stand including a pair of collapsible ladder portions pivotably connected to said truck bed portion of said pickup truck, and a platform portion connecting said ladder sections together when assembled.

3. A game stand device configured for use with a pickup truck, said game stand device comprising:
a ladder portion;
a platform portion; and
a collapsible support portion configured to be supported by a truck bed portion of said pickup truck, said collapsible support portion connected to and supporting said platform portion when assembled.

4. A device according to claim 1, wherein said side rails of a truck bed portion of said pickup truck are provided with a pair of eyelet connectors configured for pivotably connecting said ladder sections to said side rails of said truck bed portion of said pickup truck.

5. A device according to claim 4, wherein lower ends of said ladder sections are provided with yoke connectors for connecting with and accommodating said eyelet connectors, and including a removable bolt connecting said yoke connectors to said eyelet connectors.

6. A device according to claim 4, wherein said eyelet connectors are configured to connect with receivers provide in an upper end of said side rails of said truck bed portion of said pickup truck.

7. A device according to claim 2, wherein said ladder sections are configured to fold and unfold.

8. A device according to claim 2, wherein said ladder sections includes telescoping leg portions.

9. A device according to claim 2, including at least one cross-member releaseably connecting said ladder sections together.

10. A device according to claim 3, wherein said collapsible support is supported by a floor of said truck bed portion of said pickup truck.

11. A device according to claim 3, wherein said collapsible support is supported by side rails of said truck bed portion of said pickup truck.

12. A device according to claim 3, wherein said collapsible support is stabilized relative to said pickup truck when assembled by at least one selected from the group consisting of a rope, wire, strap and cable.

13. A device according to claim 3, wherein a bottom end of each ladder section is provided with an out-rigging member to stabilize said game stand device.

14. A device according to claim 2, including a storage box configured for storing said game stand device.

15. A device according to claim 14, wherein said storage box is configured for resting on top of side rails of a truck bed portion of said pickup truck.

16. A device according to claim 3, including a storage box configured for storing said game stand device.

17. A device according to claim 16, wherein said storage box is configured for resting on top of side rails of a truck bed portion of said pickup truck.

18. A device according to claim 1, including a seat provided on said platform portion.

19. A device according to claim 1, including a tent portion provided above said platform portion.

20. A device according to claim 18, including a tent portion provided above said platform portion.
